(19) United States
(12) Patent Application Publication
(10) Pub. No.: US 2025/0121651 A1
(43) Pub. Date: Apr. 17, 2025

(54) AIR CONDITIONING SYSTEM FOR A VEHICLE

(71) Applicants: HYUNDAI MOTOR COMPANY, Seoul (KR); KIA CORPORATION, Seoul (KR); HANON SYSTEMS, Daejeon (KR)

(72) Inventors: Kwang Ok Han, Seoul (KR); Myung Hoe Kim, Seoul (KR); Kwang Woon Cho, Yongin-si (KR); Su Yeon Kang, Seoul (KR); Tae Yong Park, Daejeon (KR); Jeung Sik Shin, Daejeon (KR); Jae Chun Ryu, Daejeon (KR)

(73) Assignees: HYUNDAI MOTOR COMPANY, Seoul (KR); KIA CORPORATION, Seoul (KR); HANON SYSTEMS, Daejeon (KR)

(21) Appl. No.: 18/611,049

(22) Filed: Mar. 20, 2024

(30) Foreign Application Priority Data
Oct. 16, 2023 (KR) 10-2023-0137951

(51) Int. Cl. B60H 1/00

(52) U.S. Cl. CPC B60H 1/00664; B60H 1/00564

(57) ABSTRACT

An air conditioning system for a vehicle includes a condenser and an evaporator disposed to face each other in a housing, which simplifies a refrigerant circuit, reduces a flow path for air, and reduces a thermal loss that may occur when air flows.

### CROSS REFERENCE TO RELATED APPLICATION

The present application claims priority to Korean Patent Application No. 10-2023-0137951, filed on Oct. 16, 2023, the entire contents of which are incorporated herein for all purposes by this reference.

### BACKGROUND OF THE DISCLOSURE

### Technical Field

The present disclosure relates to an air conditioning system for a vehicle (e.g., mobility device, mobility apparatus, mobility instrument), and more particularly, to an air conditioning system for a vehicle, in which a condenser and an evaporator are disposed to face each other in a housing. The air conditioning system according to the present disclosure simplifies a refrigerant circuit, reduces the length of a flow path for air, and reduces thermal loss that may occur when air flows.

### Description of the Related Art

In general, an air conditioning device is a front air conditioning device and is configured to discharge cooling air or heating air from discharge ports formed in an instrument panel disposed at a front side of an interior of a vehicle. For this reason, in the case of a vehicle with a large interior space, a rear seat may not be sufficiently cooled or heated.

Therefore, in order to assist in cooling or heating the rear seat, a rear seat air conditioning device or a roof-type air conditioning device is provided. The rear seat air conditioning device or roof-type air conditioning device is installed on a roof of the vehicle and is configured to discharge air-conditioning air from above an occupant's head.

In particular, the roof-type air conditioning device has a heat exchanger configured to exchange heat with outside air. The heat exchanger is also installed on the roof. However, there is a limitation in the quantity of outside air that may be provided to the heat exchanger within a limited space on the roof.

In addition, recently, various autonomous vehicles have been developed. The autonomous vehicles may travel in two directions (e.g., a left direction and a right direction) as well as a forward/rearward direction. However, in the related art, a portion through which outside air is introduced to the roof-type air conditioning device is restrictively provided at the front side, which makes it impossible to sufficiently introduce outside air that needs to be provided to the heat exchanger of the roof-type air conditioning device when the vehicle travels in a left direction, a right direction, or a rearward direction.

In addition, when the heat exchangers are disposed to perform air conditioning for the front seats and the rear seats independently, the arrangement of pipes is complicated, additional components, such as a separate valve, are required, and an overall size is increased, which is disadvantageous in terms of packaging.

The foregoing explained as the background is intended merely to aid in understanding the background of the present disclosure. Thus, the foregoing is not intended to mean that the present disclosure falls within the purview of the related art that is already known to those of ordinary skill in the art.

### SUMMARY OF THE DISCLOSURE

The present disclosure is proposed to solve these problems and aims to provide an air conditioning system for a vehicle, in which a condenser and an evaporator are disposed to face each other in a housing, simplifying a refrigerant circuit, reducing the length of a flow path for air, and reducing thermal loss that may occur when air flows.

In order to achieve the above-mentioned object, the present disclosure provides an air conditioning system for a vehicle. The system includes a housing having an internal space connected to an air inlet path and an air outlet path. The air outlet path is divided into an internal passage and an external passage. Additionally, the air conditioning system includes air conditioning doors provided in the housing and configured to allow air to selectively flow to the internal passage or the external passage. The air conditioning system includes a first heat exchange unit provided in the internal space of the housing and a second heat exchange unit provided to face the first heat exchange unit in the internal space of the housing. Air is introduced into the internal space through the air inlet path flows to the first heat exchange unit and the second heat exchange unit. Additionally, the air introduced to the internal space is discharged to a vehicle interior or exterior, depending on open/closed positions of the air conditioning doors.

The first heat exchange unit may include a first heat exchanger and a first blower and the second heat exchange unit may include a second heat exchanger and a second blower.

The internal space of the housing may include a flow space and first and second air conditioning spaces disposed to be spaced apart from each other. The air inlet path may be connected to the flow space. The first and second air outlet paths may be respectively connected to the first and second air conditioning spaces.

The air inlet path may be divided into an inside air inlet path and an outside air inlet path. Inside/outside air doors may be provided in the housing and selectively open or close the inside air inlet path and the outside air inlet path.

The inside/outside air doors may include a first inside/outside air door and a second inside/outside air door. The first inside/outside air door may be installed in the flow space of the housing, correspond to the first heat exchange unit, and adjust a flow amount of inside air or outside air flowing to the first heat exchange unit. The second inside/outside air door may be installed in the flow space of the housing, correspond to the second heat exchange unit, and adjust a flow amount of inside air or outside air flowing to the second heat exchange unit.

A filter may be provided in the flow space of the housing.

The first heat exchange unit may be provided in the first air conditioning space. The second heat exchange unit may be provided in the second air conditioning space. The first heat exchange unit and the second heat exchange unit may be disposed to face each other.

The air conditioning doors may include a first air conditioning door and a second air conditioning door. The first air conditioning door may be provided at a branch point between the external passage and the internal passage connected to the first air conditioning space and determine a flow route for the air having passed through the first heat exchange unit. The second air conditioning door may be provided at a branch point between the external passage and the internal passage connected to the second air conditioning space and determine a flow route for the air having passed through the first heat exchange unit.

The first air outlet path may be divided into a plurality of routes in the first air conditioning space. The second air outlet path may be divided into a plurality of routes in the second air conditioning space. The external passage of the first air outlet path and the external passage of the second air outlet path may extend in the same direction.

The housing may include a first duct part connected to the internal passage of the first air outlet path and a second duct part connected to the internal passage of the second air outlet path. Each of the first and second duct parts may extend and include a plurality of routes to provide air-conditioning air to different regions in the vehicle interior.

The external passage of the first air outlet path and the external passage of the second air outlet path may extend in a direction opposite to a traveling direction. Outlets of the external passages may be positioned in the direction opposite to the traveling direction.

The first air outlet path may be divided into a plurality of routes in the first air conditioning space. The second air outlet path may be divided into a plurality of routes in the second air conditioning space. The housing may include a first discharge duct configured to communicate with the external passage of the first air outlet path, and a second discharge duct configured to communicate with the external passage of the second air outlet path.

The first and second discharge ducts may be formed to be open in a traveling direction.

The housing may be installed on a roof of a vehicle, the air inlet path may be divided into an inside air inlet path and an outside air inlet path, the inside air inlet path may be provided in a lower surface of the housing and communicate with the vehicle interior, and the outside air inlet path may be provided in a lateral or upper surface of the housing and communicate with the exterior.

According to the air conditioning system for a vehicle structured as described above, the condenser and the evaporator are disposed to face each other in the housing, simplifying the refrigerant circuit, reducing a length of the flow path for air, and reducing thermal loss that may occur when air flows.

### BRIEF DESCRIPTION OF THE DRAWINGS

FIG. 1 is a view illustrating an air conditioning system for a vehicle according to the present disclosure.

FIG. 2 is a view illustrating a housing of the air conditioning system for a vehicle illustrated in FIG. 1.

FIG. 3 is a view illustrating an interior of the housing of the air conditioning system for a vehicle according to an embodiment.

FIG. 4 is a view illustrating an air inlet path and an air outlet path in a housing of an air conditioning system for a vehicle according to another embodiment.

FIG. 5 is a view illustrating the air inlet path and the air outlet path in the housing of the air conditioning system for a vehicle illustrated in FIG. 4.

FIG. 6 is a top plan view of the air conditioning system for a vehicle illustrated in FIG. 4.

FIG. 7 is a bottom plan view of the air conditioning system for a vehicle illustrated in FIG. 4.

FIG. 8 is a view illustrating inside/outside air doors in the housing of the air conditioning system for a vehicle.

FIG. 9 is a view illustrating a cooling mode of the air conditioning system for a vehicle according to the present disclosure.

FIG. 10 is a view illustrating a heating mode of the air conditioning system for a vehicle according to the present disclosure.

FIG. 11 is a view illustrating a mixing mode of the air conditioning system for a vehicle according to the present disclosure.

FIG. 12 is a view illustrating an air conditioning system

for a vehicle according to still another embodiment.

### DETAILED DESCRIPTION

Hereinafter, embodiments disclosed in the present specification are described in detail with reference to the accompanying drawings. The same or similar constituent elements are assigned with the same reference numerals throughout the written description and drawings, and a repetitive description thereof has been omitted.

The terms “module”, “unit”, “part”, and “portion” are used to describe constituent elements in the following description are used together or interchangeably in order to facilitate description, but the terms themselves do not have distinguishable meanings or functions.

In the description of the embodiments disclosed in the present specification, specific descriptions of publicly known related technologies have been omitted where it has been determined that a specific description thereof may obscure the subject matter of the embodiments disclosed in the present specification. In addition, it should be interpreted that the accompanying drawings are provided only to allow those of ordinary skill in the art to readily understand the embodiments disclosed in the present specification. The technical spirit disclosed in the present specification is not limited by the accompanying drawings, and includes all alterations, equivalents, and alternatives that are included in the spirit and the technical scope of the present inventive concept.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as different meanings in the context.

In the present specification, it should be understood that the terms “comprises,” “comprising,” “includes,” “including,” “containing,” “has,” “having” or other variations thereof are inclusive and therefore specify the presence of stated features, integers, steps, operations, elements, components, or combinations thereof. Such terms do not preclude the presence or addition of one or more other features, integers, steps, operations, elements, components, or combinations thereof.

A controller may include a communication device configured to communicate with another control unit or a sensor to control a corresponding function, a memory configured to store an operating system, a logic instruction, and input/output information, and one or more processors configured to perform determination, computation, decision, or the like required to control the corresponding function.

Hereinafter, an air conditioning system for a vehicle according to embodiments of the present disclosure is described with reference to the accompanying drawings. When a component, device, element, or the like of the present disclosure is described as having a purpose or performing an operation, function, or the like, the component, device, or element should be considered herein as being “configured to” meet that purpose or perform that operation or function.

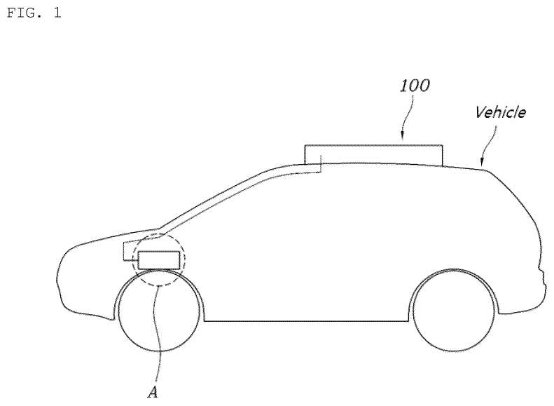

As illustrated in FIGS. 1-3 according to the present disclosure, the air conditioning system includes a housing 100 having an internal space S connected to an air inlet path 110 and an air outlet path 120. The air outlet path 120 is divided into internal passages 121 and external passages 122. The air conditioning system further includes air conditioning doors 200 provided in the housing 100 and configured to allow air to selectively flow to the internal passages 121 or the external passages 122, a first heat exchange unit 300 provided in the internal space S of the housing 100, and a second heat exchange unit 400 provided in the internal space S of the housing 100 and configured to face the first heat exchange unit 300.

The housing 100 may be installed at an upper side of a vehicle and constitute a roof-type air conditioning system.

The first heat exchange unit 300 and the second heat exchange unit 400 are provided in the internal space S of the housing 100 and connected to the air inlet path 110 and the air outlet path 120.

The first heat exchange unit 300 includes a first heat exchanger 310 and a first blower 320. The second heat exchange unit 400 includes a second heat exchanger 410 and a second blower 420. The first blower 320 and the second blower 420 may operate by receiving an instruction from a controller.

In this case, the first heat exchanger 310 may be a condenser, and the second heat exchanger 410 may be an evaporator. The first heat exchanger 310 and the second heat exchanger 410 are connected to a refrigerant circuit. Refrigerants exchange heat with air while circulating in the first heat exchanger 310 and the second heat exchanger 410. Therefore, the first heat exchanger 310 creates heating air-conditioning air by means of heat exchange between the refrigerant and the air, and the second heat exchanger 410 creates cooling air-conditioning air by means of heat exchange between the refrigerant and the air.

Refrigerant circulation components A including a compressor, a water-cooled condenser, and the like are provided in the refrigerant circuit. As illustrated in FIG. 1, the refrigerant circulation components A may be installed to be separated in a different region of the vehicle.

As described above, when the first blower 320 of the first heat exchange unit 300 operates, air introduced through the air inlet path 110 may be heated by means of the heat exchange in the first heat exchanger 310 and then discharged to the vehicle interior or exterior through the air outlet path 120. In addition, when the second blower 420 of the second heat exchange unit 400 operates, air introduced through the air inlet path 110 may be cooled by means of the heat exchange in the second heat exchanger 410 and then discharged to the vehicle interior or exterior through the air outlet path 120.

In this case, the air outlet path 120 of the housing 100 is divided into the internal passages 121 and the external passages 122. In addition, air conditioning doors 200 are provided in the housing 100 to allow the air to selectively flow to the internal passage 121 or the external passage 122. Inside/outside air doors 500, which includes the air conditioning doors 200 and are described below, may operate under the control of the controller.

The heated air having passed through the first heat exchange unit 300 or the cooled air having passed through the second heat exchange unit 400 may be provided to the vehicle interior or discharged to the outside depending on open or closed positions of the air conditioning doors 200. An operation of opening and/or closing the air conditioning doors 200 may be performed to control whether the heated air or the cooled air is provided to the vehicle interior or discharged to the outside.

In particular, in the present disclosure, the first heat exchange unit 300 and the second heat exchange unit 400 are disposed to face each other in the internal space S. Therefore, the air, which is introduced into the internal space S through the air inlet path 110 of the housing 100, simultaneously flows to the first heat exchange unit 300 and the second heat exchange unit 400 and heat exchange is performed.

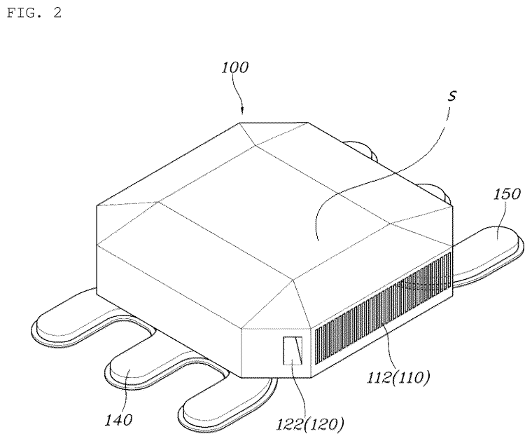

In addition, the internal passages 121 of the air outlet path 120 in the housing 100 extend and branch off from the air outlet path 120 toward various regions in the vehicle interior. As illustrated in FIG. 2, the internal passages 121 of the air outlet path 120 may extend forward and rearward to provide the air-conditioning air to front and rear regions of the vehicle interior. As described above, the air, which has exchanged heat while passing through the first heat exchange unit 300 and the second heat exchange unit 400, may be discharged to the vehicle interior or exterior depending on open or closed positions of the air conditioning doors 200 provided in the housing 100.

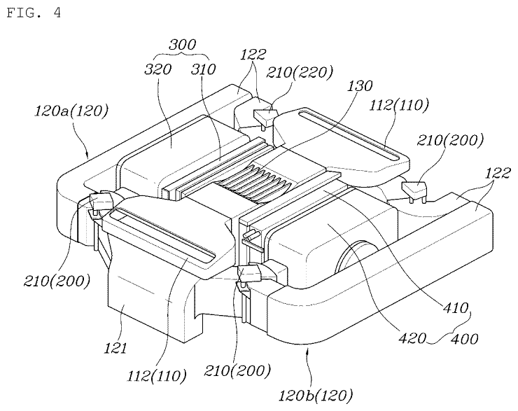

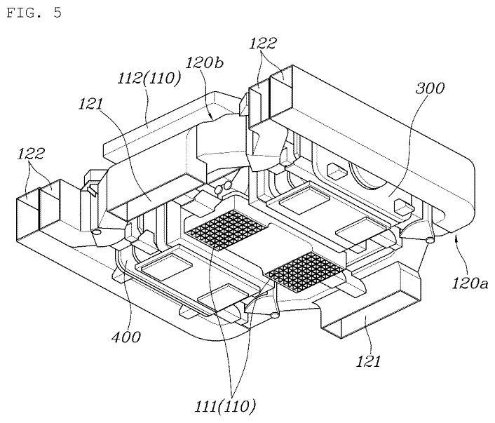

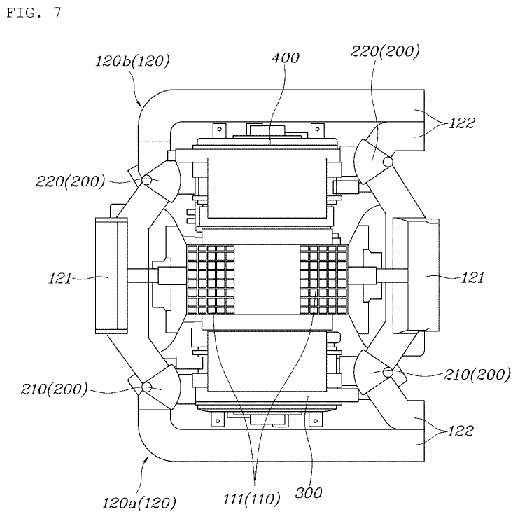

The present disclosure is described in greater detail hereinafter. As illustrated in FIGS. 4-8, the internal space S of the housing 100 includes a flow space S1 and first and second air conditioning spaces S2 and S3 disposed to be spaced apart from each other based on the flow space S1. The air inlet path 110 may be connected to the flow space S1. First and second air outlet paths 120a and 120b may be respectively connected to the first and second air conditioning spaces S2 and S3.

In other words, the internal space S of the housing 100 includes the flow space S1, the first air conditioning space S2, and the second air conditioning space S3. The first air conditioning space S2 and the second air conditioning space S3 are positioned based on the flow space S1. In this case, the first heat exchange unit 300 is provided in the first air conditioning space S2, and the second heat exchange unit 400 is provided in the second air conditioning space S3, such that the first heat exchange unit 300 and the second heat exchange unit 400 are disposed to face each other based on the flow space S1.

Therefore, when air is introduced into the flow space S1 through the air inlet path 110, the air is distributed to the first air conditioning space S2 and the second air conditioning space S3, such that the air is transmitted to both the first heat exchange unit 300 and the second heat exchange unit 400.

The first air outlet path 120a is connected to the first air conditioning space S2, such that the air, which has exchanged heat with the first heat exchange unit 300, is discharged to the vehicle interior or exterior depending on the open/closed position of the air conditioning door 200 provided in the first air outlet path 120a.

The second air outlet path 120b is connected to the second air conditioning space S3, such that the air, which has exchanged heat with the second heat exchange unit 400, is discharged to the vehicle interior or exterior depending on the open/closed position of the air conditioning door 200 provided in the second air outlet path 120b.

The air inlet path 110 is divided into an inside air inlet path 111 and an outside air inlet path 112. The inside/outside air doors 500 may be disposed in the housing 100 to selectively open or close the inside air inlet path 111 and the outside air inlet path 112.

The inside air inlet path 111 is connected to the vehicle interior, and the outside air inlet path 112 is connected to the exterior.

In the present disclosure, in case that the housing 100 is installed on a roof of the vehicle, the air inlet path 110 may be divided into the inside air inlet path 111 and the outside air inlet path 112. The inside air inlet path 111 may be provided in a lower surface of the housing 100 and communicate with the vehicle interior. The outside air inlet path 112 may be provided in a lateral or upper surface of the housing 100 and communicate with the exterior of the vehicle.

In a case where the housing 100 is installed on the roof of the vehicle as described above, the inside air inlet path 111 is positioned at a lower side of the flow space S1 and minimizes the length of a route connected to the vehicle interior. The outside air inlet path 112 is positioned at a lateral or upper side of the housing 100, facilitating the introduction of outside air, and preventing interference between the components.

In other words, as illustrated in FIGS. 4-7, the outside air inlet path 112 may be formed to be directed upward or vertically to prevent interference with other components including the heat exchanger units, and the inside air inlet path 111 may be formed to be directed downward to provide the air-conditioning air to the vehicle interior.

The inside air inlet path 111 and the outside air inlet path 112 communicate with the flow space S1. The inside/outside air doors 500 are provided in the flow space S1, such that an amount of inside air introduced, and an amount of outside air introduced may be controlled. Therefore, a fresh air mode, a recirculation mode, and an inside/outside air mixing mode may be implemented depending on a degree to which the inside/outside air doors 500 are open.

In the present disclosure, because the first heat exchange unit 300 and the second heat exchange unit 400 are provided in the housing 100, the inside/outside air doors 500 include a first inside/outside air door 510 and a second inside/outside air door 520 to selectively provide inside air or outside air to the heat exchange units.

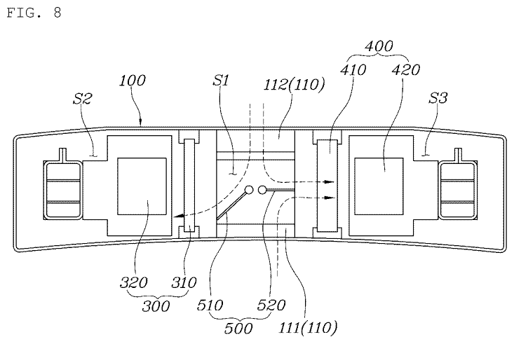

As illustrated in FIG. 8, the first inside/outside air door 510 is installed in the flow space S1 of the housing 100, corresponds to the first heat exchange unit 300, and adjusts an amount of inside air and/or outside air flowing to the first heat exchange unit 300.

In addition, the second inside/outside air door 520 is installed in the flow space S1 of the housing 100, corresponds to the second heat exchange unit 400, and adjusts an amount of inside air and/or outside air flowing to the second heat exchange unit 400.

For example, with reference to FIG. 8, when the first inside/outside air door 510 is positioned to be opened toward the outside air inlet path 112 in the fresh air mode, the outside air introduced through the outside air inlet path 112 may exchange heat while passing through the first heat exchange unit 300.

When the second inside/outside air door 520 is positioned between the inside air inlet path 111 and the outside air inlet path 112 in the inside/outside air mixing mode, the inside air and the outside air, which are mixed through the inside air inlet path 111 and the outside air inlet path 112, may exchange heat while passing through the second heat exchanger 410.

The first inside/outside air door 510 and the second inside/outside air door 520 may have various shapes, such as a dome door shape and a flap door shape, depending on installation positions and installation spaces thereof, a position of the inside air inlet path 111, and a position of the outside air inlet path 112.

Meanwhile, a filter 130 is provided in the flow space S1 of the housing 100. The filter 130 is configured to remove foreign substances from the air introduced into the flow space S1 through the inside air inlet path 111 and the outside air inlet path 112. The filter 130 may be divided into a filter (e.g., a first filter) at a side adjacent to the first heat exchange unit 300 and a filter (e.g., a second filter) adjacent to a side of the second heat exchange unit 400 in the flow space S1. Alternatively, a single filter 130 may be provided in the flow space S1.

Meanwhile, the air conditioning doors 200 include first air conditioning doors 210 and second air conditioning doors 220.

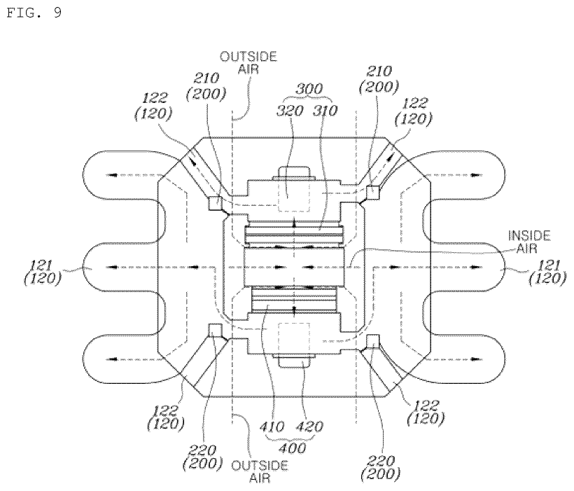

As illustrated in FIGS. 4 and 9, the first air conditioning doors 210 are provided at branch points between the internal passage 121 and the external passage 122 connected to the first air conditioning space S2 and determine a flow route for the air having passed through the first heat exchange unit 300.

The second air conditioning doors 220 are provided at branch points between the internal passage 121 and the external passage 122 connected to the second air conditioning space S3 and determines a flow route for the air having passed through the second heat exchange unit 400.

In the present disclosure, the air outlet path 120 may be divided forward and rearward to provide the air-conditioning air to various regions in the vehicle interior. The first air conditioning doors 210 may be provided as a plurality of first air conditioning doors 210, and the second air conditioning doors 220 may be provided as a plurality of second air conditioning doors 220.

Therefore, depending on the open/closed position of the first air conditioning doors 210, the air having passed through the first heat exchange unit 300 may flow from the first air outlet path 120a to the internal passage 121 so that the heating air may be provided to the vehicle interior, or the air having passed through the first heat exchange unit 300 may be discharged to the exterior through the external passage 122 from the first air outlet path 120a.

In addition, depending on the open/closed position of the second air conditioning doors 220, the air having passed through the second heat exchange unit 400 may flow from the second air outlet path 120b to the internal passage 121 so that the cooling air may be provided to the vehicle interior, or the air having passed through the second heat exchange unit 400 may be discharged to the exterior through the external passage 122 from the second air outlet path 120b.

As described above, the cooling and heating air-conditioning air may be selectively provided to the vehicle interior by means of the first air conditioning doors 210 and the second air conditioning doors 220, and the air, which has exchanged heat with the heat exchange units and managed the temperature of the refrigerant, may be discharged to the exterior, thereby facilitating the management of the temperature of the vehicle interior and the temperature of the refrigerant.

Meanwhile, the housing 100 may have a first duct part 140 connected to the internal passage 121 of the first air outlet path 120a, and a second duct part 150 connected to the internal passage 121 of the second air outlet path 120b. The first duct part 140 and the second duct part 150 may extend as a plurality of routes to provide the air-conditioning air to different regions in the vehicle interior.

The first duct part 140 and the second duct part 150 are configured to provide the vehicle interior with the air-conditioning air having a temperature adjusted by the first heat exchange unit 300 or the second heat exchange unit 400 in the housing 100.

For example, the first duct part 140 is connected to the internal passage 121 of the first air outlet path 120a. The first duct part 140 is divided into the plurality of routes connected to different positions in a front region in the vehicle interior so that the air-conditioning air having passed through the first heat exchange unit 300 or the second heat exchange unit 400 May be provided to the front region in the vehicle interior.

The second duct part 150 is connected to the internal passage 121 of the second air outlet path 120b. The second duct part 150 is divided into the plurality of routes connected to different positions in a rear region in the vehicle interior so that the air-conditioning air having passed through the first heat exchange unit 300 or the second heat exchange unit 400 may be provided to the rear region in the vehicle interior.

As described above, the air-conditioning air, which has a temperature that has been adjusted by the first heat exchange unit 300 and the second heat exchange unit 400 in the housing 100, may be provided to various regions in the vehicle interior through the first duct part 140 and the second duct part 150. Particularly, the air-conditioning air may be provided to various regions including the front and rear regions in the vehicle interior from the single housing 100, such that the size of an entire package or device for conditioning air in the vehicle interior may be reduced.

According to the present disclosure, various modes may be implemented as follows.

As illustrated in FIG. 9, in a cooling mode, the air introduced into the housing 100 through the air inlet path 110 simultaneously flows to the first heat exchange unit 300 and the second heat exchange unit 400. In this case, the air, which has exchanged heat with, and thus adjusted the temperature of, the refrigerant while passing through the first heat exchange unit 300, is discharged to the outside through the external passage 122 of the air outlet path 120 by the first air conditioning doors 210. The cooling air cooled while passing through the second heat exchange unit 400 is provided to the vehicle interior through the internal passage 121 of the air outlet path 120 by the second air conditioning doors 220.

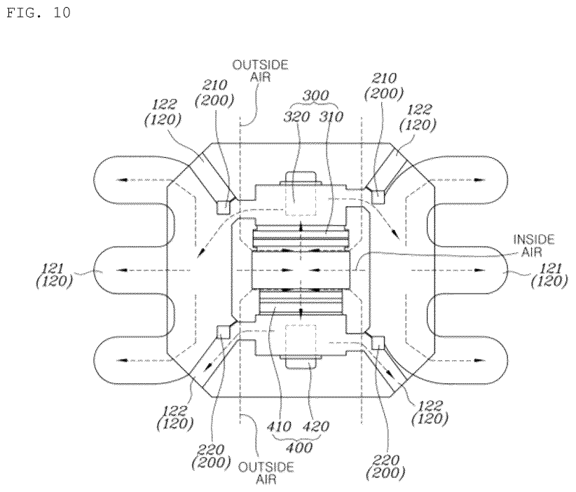

As illustrated in FIG. 10, in a heating mode, the air introduced into the housing 100 through the air inlet path 110 simultaneously flows to the first heat exchange unit 300 and the The heating air heated while second heat exchange unit 400. passing through the first heat exchange unit 300 is provided to the vehicle interior through the internal passage 121 of the air outlet path 120 by the first air conditioning doors 210. In addition, the air, which has exchanged heat with, and thus adjusted the temperature of the refrigerant while passing through the second heat exchange unit 400, is discharged to the outside through the external passage 122 of the air outlet path 120 by the second air conditioning doors 220.

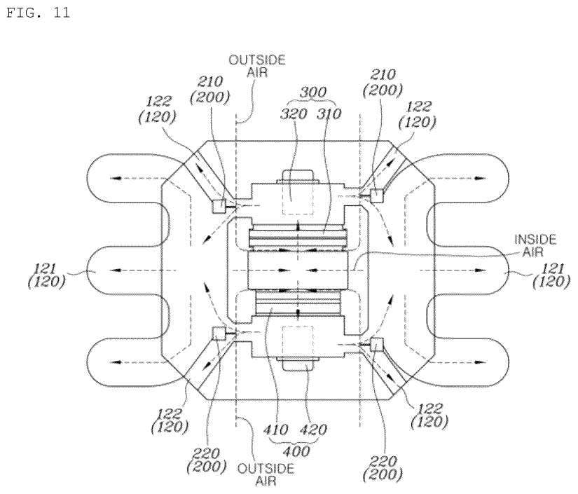

As illustrated in FIG. 11, in a heating/dehumidification mode, the air introduced into the housing 100 through the air inlet path 110 simultaneously flows to the first heat exchange unit 300 and the second heat exchange unit 400. In this case, the inside/outside air doors 500 may operate to introduce outside air to dehumidify the vehicle interior.

In this case, a portion of the heating air heated while passing through the first heat exchange unit 300 is provided to the vehicle interior through the internal passage 121 of the air outlet path 120 by the first air conditioning doors 210, and the remaining portion of the heating air is discharged to the outside through the external passage 122. In addition, a portion of the cooling air cooled while passing through the second heat exchange unit 400 is provided to the vehicle interior through the internal passage 121 of the air outlet path 120 by the second air conditioning doors 220, and the remaining portion of the cooling air is discharged to the outside through the external passage 122.

Therefore, the air, which has been heated by the first heat exchange unit 300, and the air, which has been dehumidified by the second heat exchange unit 400, are mixed and introduced into the vehicle interior, such that the dehumidified air may be provided to the vehicle interior while heating the vehicle interior.

According to the present inventive concept described above, various modes may be implemented by controlling an opening degree of the air conditioning doors 200, and various modes other than the above-mentioned modes may be implemented.

In the present disclosure, the first air outlet path 120a is divided into a plurality of routes in the first air conditioning space S2, and the second air outlet path 120b is divided into a plurality of routes in the second air conditioning space S3.

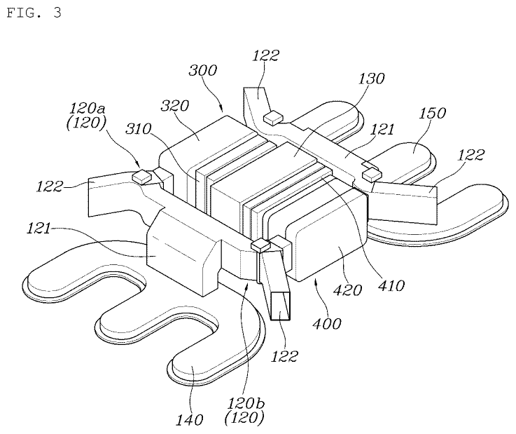

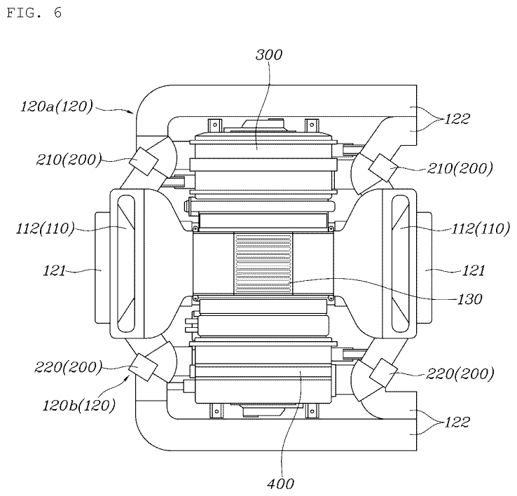

In other words, as illustrated in FIGS. 3 and 6, the first air conditioning space S2 and the second air conditioning space S3 are disposed to face each other based on the flow space S1, and the first air conditioning space S2 and the second air conditioning space S3 are each divided into a plurality of routes depending on regions in the vehicle interior. For example, in FIG. 6, the left side of the housing 100 may be the front side of the vehicle interior, and the right side of the housing 100 may be the rear side of the vehicle interior.

In this case, as illustrated in FIG. 3, the external passage 122 of the first air outlet path 120a and the external passage 122 of the second air outlet path 120b may extend to communicate with the outside of the housing 100.

In addition, in another embodiment, as illustrated in FIG. 6, the external passage 122 of the first air outlet path 120a and the external passage 122 of the second air outlet path 120b may extend in the same direction.

In other words, the external passages 122 of the first air outlet path 120a and the external passages 122 of the second air outlet path 120b both extend in any one (e.g., a single) direction in the same way, such that discharge directions of the air through the external passages 122 of the air outlet path 120 may be coincident with one another.

In this case, the external passage 122 of the first air outlet path 120a and the external passage 122 of the second air outlet path 120b may extend in a direction opposite to the traveling direction, such that outlets of the external passages 122 may be positioned in the direction opposite to the traveling direction.

Therefore, the air may be smoothly discharged in the direction opposite to the traveling direction through the external passage 122 of the air outlet path 120, such that a reverse flow of the discharged air is prevented.

Meanwhile, in still another embodiment, the housing 100 may include a first discharge duct 160 configured to communicate with the external passages 122 of the first air outlet paths 120a, and a second discharge duct 170 configured to communicate with the external passages 122 of the second air outlet paths 120b.

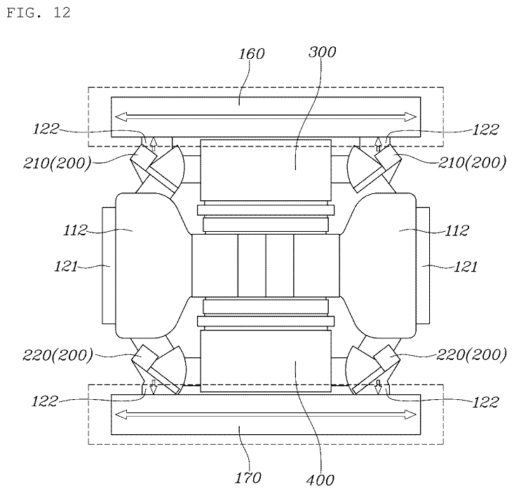

As illustrated in FIG. 12, the first discharge duct 160 may be connected to the external passages 122 that constitute the plurality of first air outlet paths 120a, and the first discharge duct 160 may be formed to be opened in the traveling direction of the vehicle.

In addition, the second discharge duct 170 may be connected to the external passages 122 that constitute the plurality of second air outlet paths 120b, and the second discharge duct 170 may be formed to be opened in the traveling direction of the vehicle.

Therefore, when the air is discharged through the external passages 122 of the first air outlet paths 120a and the second air outlet paths 120b, vehicle-induced wind (e.g., air moving relative to the vehicle) passes through the first discharge duct 160 or the second discharge duct 170 and flows together with the air discharged through the external passages 122, thereby improving performance in discharging the air. In addition, a reverse flow of the discharged air is prevented, and adequate performance in discharging the air is ensured even when the vehicle travels in the forward or reverse direction.

While specific embodiments of the present disclosure have been illustrated and described, it should be obvious to those of ordinary skill in the art that the present inventive concept may be variously modified and changed without departing from the technical spirit of the present inventive concept defined in the appended claims.

What is claimed is:

1. An air conditioning system for a vehicle, the air conditioning system comprising:
a housing having an internal space connected to an air inlet path and an air outlet path, the air outlet path being divided into an internal passage and an external passage;
air conditioning doors provided in the housing and configured to allow air to selectively flow to the internal passage or the external passage;
a first heat exchange unit provided in the internal space of the housing; and
a second heat exchange unit provided to face the first heat exchange unit in the internal space of the housing,
wherein air introduced into the internal space through the air inlet path flows to the first heat exchange unit and the second heat exchange unit, and
wherein the air is discharged to a vehicle interior or exterior, depending on open or closed positions of the air conditioning doors.

2. The air conditioning system of claim 1, wherein the first heat exchange unit comprises a first heat exchanger and a first blower, and
wherein the second heat exchange unit comprises a second heat exchanger and a second blower.

3. The air conditioning system of claim 1, wherein the internal space of the housing includes a flow space and first and second air conditioning spaces disposed to be spaced apart from each other,
wherein the air inlet path is connected to the flow space, and
wherein first and second air outlet paths are respectively connected to the first and second air conditioning spaces.

4. The air conditioning system of claim 3, wherein the air inlet path is divided into an inside air inlet path and an outside air inlet path, and
wherein inside/outside air doors are provided in the housing and selectively open or close the inside air inlet path and the outside air inlet path.

5. The air conditioning system of claim 4, wherein the inside/outside air doors comprise a first inside/outside air door and a second inside/outside air door,
wherein the first inside/outside air door is installed in the flow space of the housing, corresponds to the first heat exchange unit, and adjusts an amount of inside air or outside air flowing to the first heat exchange unit, and
wherein the second inside/outside air door is installed in the flow space of the housing, corresponds to the second heat exchange unit, and adjusts an amount of inside air or outside air flowing to the second heat exchange unit.

6. The air conditioning system of claim 3, wherein a filter is provided in the flow space of the housing.

7. The air conditioning system of claim 3, wherein the first heat exchange unit is provided in the first air conditioning space,
wherein the second heat exchange unit is provided in the second air conditioning space, and
wherein the first heat exchange unit and the second heat exchange unit are disposed to face each other.

8. The air conditioning system of claim 3, wherein the air conditioning doors comprise a first air conditioning door and a second air conditioning door,
wherein the first air conditioning door is provided at a branch point between the external passage and the internal passage connected to the first air conditioning space and determines a flow route for the air having passed through the first heat exchange unit, and
wherein the second air conditioning door is provided at a branch point between the external passage and the internal passage connected to the second air conditioning space and determines a flow route for the air having passed through the first heat exchange unit.

9. The air conditioning system of claim 3, wherein the housing comprises:
a first duct part connected to the internal passage of the first air outlet path; and
a second duct part connected to the internal passage of the second air outlet path, and
wherein each of the first and second duct parts extend and include a plurality of routes to provide air-conditioning air to different regions in the vehicle interior.

10. The air conditioning system of claim 3, wherein the first air outlet path is divided into a plurality of routes in the first air conditioning space,
wherein the second air outlet path is divided into a plurality of routes in the second air conditioning space, and
wherein the external passage of the first air outlet path and the external passage of the second air outlet path extend in the same direction.

11. The air conditioning system of claim 10, wherein the external passage of the first air outlet path and the external passage of the second air outlet path extend in a direction opposite to a traveling direction, and
wherein outlets of the external passages are positioned in the direction opposite to the traveling direction.

12. The air conditioning system of claim 3, wherein the first air outlet path is divided into a plurality of routes in the first air conditioning space,
wherein the second air outlet path is divided into a plurality of routes in the second air conditioning space, and
wherein the housing comprises a first discharge duct configured to communicate with the external passage of the first air outlet path, and a second discharge duct configured to communicate with the external passage of the second air outlet path.

13. The air conditioning system of claim 12, wherein the first and second discharge ducts are formed to be open in a traveling direction.

14. The air conditioning system of claim 1, wherein the housing is installed on a roof of a vehicle,
wherein the air inlet path is divided into an inside air inlet path and an outside air inlet path,
wherein the inside air inlet path is provided in a lower surface of the housing and communicates with the vehicle interior, and
wherein the outside air inlet path is provided in a lateral or upper surface of the housing and communicates with the exterior.
